(19) United States
(12) Patent Application Publication
(10) Pub. No.: US 2008/0245337 A1
(43) Pub. Date: Oct. 9, 2008

(54) System for reducing combustor dynamics

(76) Inventors: Ramarao V. Bandaru, San Diego, CA (US); Kwanwoo Kim, Greer, SC (US); Shiva Srinivasan, Greer, SC (US); William Byrne, Simpsonville, SC (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(21) Appl. No.: 11/732,143

(22) Filed: Apr. 3, 2007

(51) Int. Cl. F02C 7/12

(52) U.S. Cl. 123/308

(57) ABSTRACT

A system for dampening combustor dynamics within a turbomachine. The system may include at least one resonator installed adjacent a head-end region of a combustion can. The at least one resonator may include a first side having a plurality of holes forming a cold side hole pattern; a second side having a plurality of holes forming a hot side hole pattern; and a cavity substantially defined by the first side and the hot side. The cold side hole pattern may be oriented such that each of the plurality of holes in the cold side hole pattern allows for a jet of a cooling air to substantially impinge a second side facing surface; and wherein the hot side hole pattern is oriented such that each of the plurality of holes in the hot side hole pattern allows for a jet of a working fluid to substantially impinges a first side facing surface.

### BACKGROUND OF THE INVENTION

The present application relates generally to a combustion system on a turbomachine; and more particularly to, a system for reducing combustor dynamics in a gas turbine combustion system.

Gas turbines generally include a compressor, a plurality of combustion cans, a fuel system, and a turbine section. Typically, the compressor pressurizes inlet air, which is then reverse flowed to the combustion cans for use in the combustion process and to cool the combustion cans. Generally, the combustion cans are located about the periphery of the gas turbine, and a transition section connects the outlet end of each combustion can with the inlet end of the turbine section.

To reduce NOₓ emissions, gas turbines may employ a lean premixed combustion system. This system generally comprises a plurality of premixers attached to each combustion can. A premixer typically includes a flow tube with a centrally disposed fuel nozzle comprising a center hub which supports fuel injectors and swirl vanes. During gas turbine operation, fuel is injected through the fuel injectors and mixes with the swirling air in the flow tube, and a flame is produced at the exit of the flow tube. Because of the typically lean stoichiometric reaction associated with lean premix combustion, lower flame temperatures and lower NOₓ emissions are achieved.

However, lean premixed combustion generally yields high frequency combustion instabilities, commonly referred to as “high frequency dynamics” or “screech dynamics”. Screech dynamics generally result from burning rate fluctuations inside the combustion cans and may create damaging pressure waves. Screech dynamics may also cause combustion component failure or severely decrease combustion component life. The frequencies and magnitudes of the screech dynamics depend on the system geometry and the gas turbine operating mode (part load, base load, or the like).

One commonly used device for dampening combustor dynamics is a resonator. Generally, a resonator comprises a closed volume (hereinafter “cavity”) connected to a throat. The resonator is commonly installed in the region where combustor dynamics are to be suppressed. The throat may be in the form of a plate having a plurality of openings. The fluid inertia of the working fluid passing through the throat openings is reacted by the volumetric stiffness of the closed cavity, producing a resonance in the velocity of flow through the openings. This flow oscillation has a well-defined natural frequency range and provides an effective mechanism for dampening acoustic energy within that range of frequencies.

Resonators used in gas turbine combustion systems, typically have the form of monolithic liners extending over large areas of the combustion system walls.

There are a few possible problems with the currently known resonators. The monolithic liners may endure high thermal stresses due to the large temperature differences that may occur between the combustion liner and outer walls of the combustion can. Monolithic liners are also difficult to install in the head-end region of a combustion can. Monolithic liners can be relatively costly to fabricate.

For the aforementioned reasons, there is a need for a resonator that can be easily installed in an area that may experience the highest screech dynamics or be located such that the pressure oscillations in the system are prevented from reaching the limit cycle by damping the inception of the oscillations, in its tuned frequency range. The resonator should adequately dampen screech dynamics that may occur during the various gas turbine operating modes. The resonator should not be relatively costly to fabricate, or have a detrimental effect on combustor durability system operation.

### BRIEF DESCRIPTION OF THE INVENTION

In accordance with an embodiment of the present invention, a system for dampening combustor dynamics, the system including a combustion system comprising a plurality of combustion cans, wherein each combustion can comprises a plurality of fuel nozzles mounted adjacent an effusion plate; and at least one resonator installed adjacent a head-end region of combustion can, the at least one resonator comprising: a first side comprising a plurality of holes forming a cold side hole pattern; a second side comprising a plurality of holes forming a hot side hole pattern; and a cavity substantially defined by the first side and the hot side; wherein the cold side hole pattern is oriented such that each of the plurality of holes in the cold side hole pattern allows for a jet of a cooling air to substantially impinge a second side facing surface; and wherein the hot side hole pattern is oriented such that each of the plurality of holes in the hot side hole pattern allows for a jet of a working fluid to substantially impinges a first side facing surface.

In accordance with another embodiment of the present invention, a system for dampening combustor dynamics, the system including: a combustion system comprising a plurality of combustion cans, wherein each combustion can comprises a plurality of fuel nozzles mounted adjacent an effusion plate; and at least one resonator installed adjacent a head-end region of combustion can, the at least one resonator comprising: a first side comprising a plurality of holes forming a cold side hole pattern; a second side comprising a plurality of holes forming a hot side hole pattern; and a cavity substantially defined by the first side and the second side; wherein the cold side hole pattern is oriented such that each of the plurality of holes in the cold side hole pattern allows for a jet of a cooling air to substantially impinge a second side facing surface; and wherein the hot side hole pattern is oriented such that each of the plurality of holes in the hot side hole pattern allows for a jet of a working fluid to substantially impinges a first side facing surface; and wherein the at least one resonator is installed around a center cap area adjacent the effusion plate.

In accordance with another embodiment of the present invention, a system for dampening combustor dynamics, the system including: a casing; a liner disposed with the casing; a combustion system disposed within the casing, the combustion system comprising a plurality of combustion cans wherein each combustion can comprises a plurality of fuel nozzles mounted adjacent an effusion plate; and at least one resonator installed adjacent a head-end region of combustion can, the at least one resonator comprising: a first side comprising a plurality of holes forming a cold side hole pattern; a second side comprising a plurality of holes forming a hot side hole pattern; and a cavity substantially defined by the first side and the second side; wherein the cold side hole pattern is oriented such that each of the plurality of holes in the cold side hole pattern allows for a jet of a cooling air to substantially impinge a second side facing surface; and wherein the hot side hole pattern is oriented such that each of the plurality of holes in the hot side hole pattern allows for a jet of a working fluid to substantially impinges a first side facing surface; wherein the at least one resonator is installed around a center cap area adjacent the effusion plate; wherein the resonator dampens pressure oscillations from about 1000 Hz to about 4000 Hz; wherein the number of holes forming the cold side hole pattern is less than the amount of holes forming the hot side hole pattern; and wherein the diameter of the each hole among the cold side hole pattern is smaller than the diameter of each hole among the hot side hole pattern.

### BRIEF DESCRIPTION OF THE DRAWING

FIG. 1 is a schematic illustrating the environment in which an embodiment of the present invention operates.

FIGS. 2A-2C, collectively FIG. 2, illustrate the upstream, elevation, and downstream views of a resonator in accordance with an embodiment of the present invention.

FIG. 3 is a schematic side view, illustrating a resonator installed within a combustion can in accordance with an embodiment of the present invention.

FIG. 4 is a schematic view facing upstream, of the resonator of FIG. 3 in accordance with an embodiment of the present invention.

FIG. 5 is a schematic view, facing upstream, illustrating the installed locations of a plurality of resonators, in accordance with an alternate embodiment of the present invention.

### DETAILED DESCRIPTION OF THE INVENTION

Certain terminology is used herein for convenience only and is not to be taken as a limitation on the invention. For example, words such as “upper,” “lower,” “left,” “front”, “right,” “horizontal,” “vertical,” “upstream,” “downstream,” “fore”, and “aft” merely describe the configuration shown in the Figures. Indeed, the components may be oriented in any direction and the terminology, therefore, should be understood as encompassing such variations unless specified otherwise.

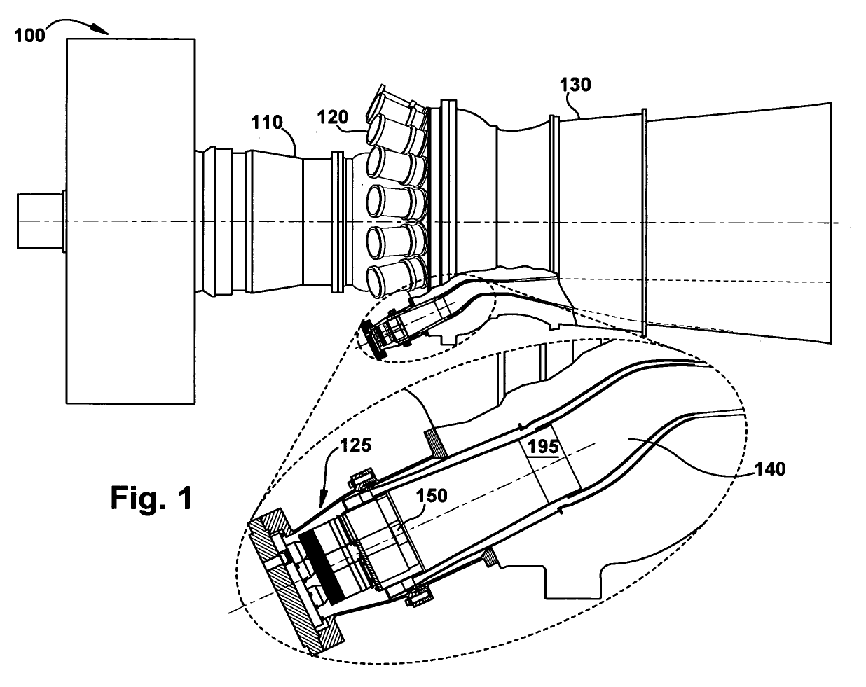

Referring now to the Figures, where the various numbers represent like parts throughout the several views, FIG. 1 is a schematic illustrating the environment in which an embodiment of the present invention operates. In FIG. 1, a gas turbine 100 includes: a compressor section 110; a plurality of combustion cans 120, with each can comprising a plurality of fuel nozzles 125; a turbine section 130; a transition section 140; a resonator 150; and a flow path 195.

Generally, the compressor section 110 includes a plurality of rotating blades (not illustrated) and stationary vanes (not illustrated) structured to compress a fluid. The plurality of combustion cans 120 may be coupled to a fuel source (not illustrated). Within each combustion can 120 the compressed air and fuel are mixed, ignited, and consumed within the flow path 195, thereby creating a working fluid. The fuel and air mixture is preferably a fuel lean stoichiometric mixture.

The flow path 195 of the working fluid generally proceeds from the aft end of the plurality of fuel nozzles 125 downstream through the transition section 140 into the turbine section 130. The turbine section 130 includes a plurality of rotating and stationary components, neither of which are shown, and converts the working fluid to a mechanical torque.

Gas turbines are generally operated at either a base load or at a part load. The load operation partly determines the amount of fuel consumption. Fluctuations in the rate of fuel consumption may create combustor dynamics, which may extend throughout the flow path 195; both upstream and downstream of the combustor can 120. When the gas turbine 100 is at base load, the peaks of the combustor dynamics are generally relatively low. However, during a transient mode switching or part load operation, the peaks of combustor dynamics may be high. Furthermore, screech dynamics, generally considered as one of the most destructive forms of dynamics, may get to higher levels during a part load operation. An embodiment of the resonator 150, of the present invention may be installed in a region within the combustion can 120 where the highest screech dynamics may occur during a part-load operation.

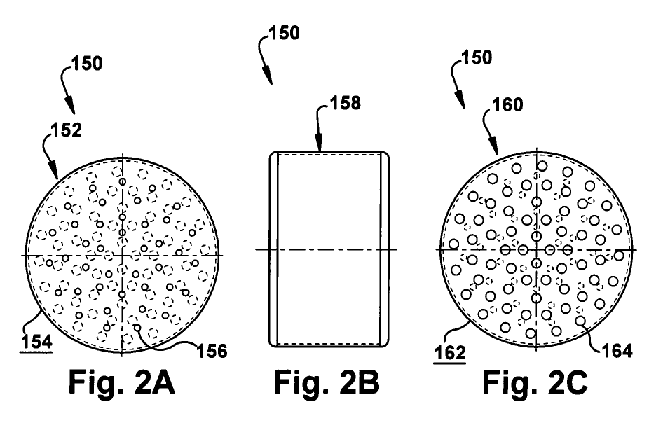

Referring now to FIGS. 2A-2C, collectively FIG. 2, which illustrate upstream, elevation, and downstream views of a resonator 150 in accordance with an embodiment of the present invention. An embodiment of the resonator 150 of the present invention comprises a first side 152, a cavity 158, and a second side 160.

FIG. 2A illustrates the first side 152 in accordance with an embodiment of the present invention. The first side 152 may include a first side facing surface 154 and a cold side hole pattern 156.

The first side 152 may form the upstream side of the resonator 150, wherein the upstream is the side closest to the compressor section 110. The first side 152 may have a plurality of holes forming a cold side hole pattern 156. The cold side hole pattern 156 may be formed through a first side facing surface 154. The cold side hole pattern 156 allows for cooling air to enter the resonator 150. The cooling air cools the second side 160, and may prevent the working fluid from back flowing into the resonator 150. In an embodiment of the present invention, the number of holes in the cold side hole pattern 156 may be configured and oriented such that a jet of cooling air flows through each hole on the cold side hole pattern 156. This may allow for the second side 160 to receive sufficient cooling air, which eventually effuses out of the second side facing surface 162.

The first side 152 may be formed of any suitable material for withstanding the normal operating conditions experienced by the resonator 150. Moreover, the first side 152 may be formed of any shape that allows for an easy and cost effective installation into the head-end of the combustion can 120. For example, but not limiting of, an embodiment of the present invention is a substantially circular plate, may have a diameter from about 3.50 inches to about 4.00 inches, and the cold side hole pattern may comprise for example, but not limiting of, from about 25 to about 50 holes.

FIG. 2B illustrates the cavity 158 of the resonator 150 in accordance with an embodiment of the present invention. The cavity 158 may be defined as the volume between the first side facing surface 154 and the second side facing surface 162 of the second side 160 (discussed below). Typically, the cavity 158 utilizes unused space in conventional combustors and is typically a closed volume. The fluid inertia of the working fluid passing through the hot side hole pattern 164 is reacted by the volumetric stiffness of the cavity 158, producing a resonance in the velocity of the working fluid through the hot side hole pattern 164. This flow oscillation generally has a well-defined natural frequency and provides an effective mechanism for absorbing acoustic energy. Therefore, the cavity 158 receives and absorbs the acoustic energy from the second side 160, dampening the screech dynamics.

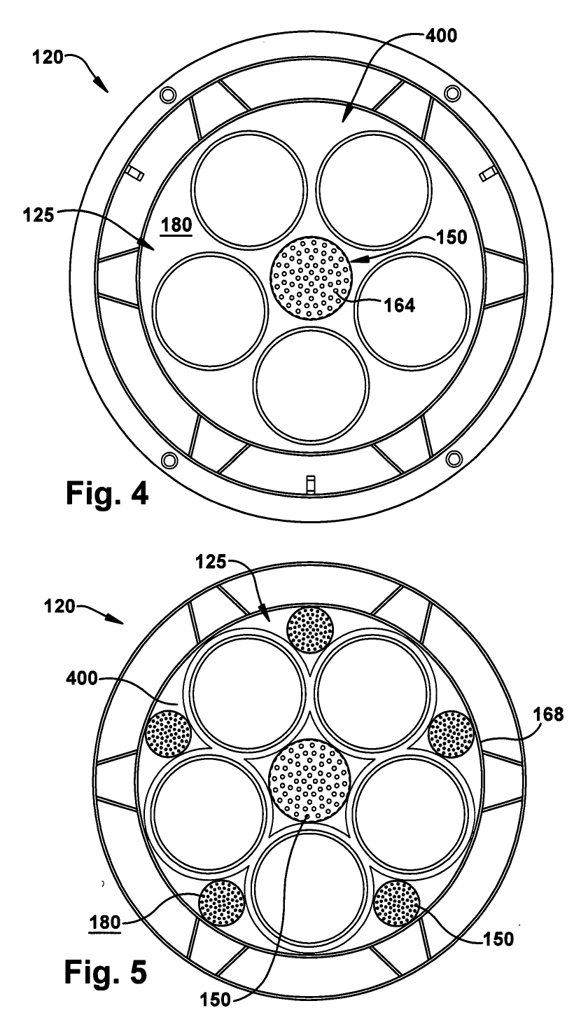

Any suitable material for withstanding the normal operating conditions experienced by the resonator 150 may enclose the cavity 158. Moreover, the cavity 158 may be formed of any shape that allows for an easy and cost effective installation into the center cap area 180 (illustrated in FIGS. 4 and 5) of the combustion can 120. For example, but not limiting of, an embodiment of the present invention is substantially cylindrical, have a diameter from about 3.50″ to about 4.00″, depth from about 2.00 inches to about 2.50 inches, and may be joined to the first side 152 and second side 160.

FIG. 2C illustrates the second side 160 in accordance with an embodiment of the present invention. The second side 160 may include a second side facing surface 162 and a hot side hole pattern 164.

The second side 160 may form the downstream side of the resonator 150, wherein the downstream side is closest to the plurality of the fuel nozzles 125 within the head-end of the combustion can 120. The second side 160 receives portion of the working fluid. The working fluid is directed through the second side 160 and flows through to the cavity 158.

The second side 160 may be axially co-located with an effusion plate (as shown in FIGS. 4 and 5) in the combustion can 120. The second side 160 may have a plurality of holes, which forms a hot side hole pattern 164. The hot side hole pattern 164 may be formed through a second side facing surface 162.

The second side 160 may be formed in any suitable material for withstanding the normal operating conditions experienced by a resonator 150. The second side 160 may be formed of any shape that allows for an easy and cost effective installation into the head-end of the combustion can 120. For example, but not limiting of, an embodiment of the present invention is a substantially circular plate and may have a diameter from about 3.50 inches to about 4.00 inches. The thickness of the second side 160 generally functions as the throat length of the resonator 150. The throat length typically serves as an important parameter for configuring a resonator to dampening dynamics of a specific frequency. An embodiment of the present invention serves to dampening screech dynamics, which occurs at frequencies of 1000 Hz or higher. The thickness of the second side 160 may range from 0.187 inches to about 0.250 inches.

The hot side hole pattern 164 may comprise for example, but not limiting of, from about 25 to about 70 holes The amount of holes in the hot side hole pattern 164 is configured and oriented such that a jet of working fluid that flows through each hole on the cold side hole pattern 156 is directed in a such a way that the jet impinges on the second side facing surface 162.

In an embodiment of the present invention the number of the plurality of holes forming the cold side hole pattern 156 may be less than the number of holes forming the hot side hole pattern 164. Furthermore, in an embodiment of the present invention, the size of each hole among the cold side hole pattern 156 may be smaller than the size of each hole among the hot side hole pattern 164. The aforementioned features may ensure that adequate directing of the working fluid and damping of the combustor dynamics occurs.

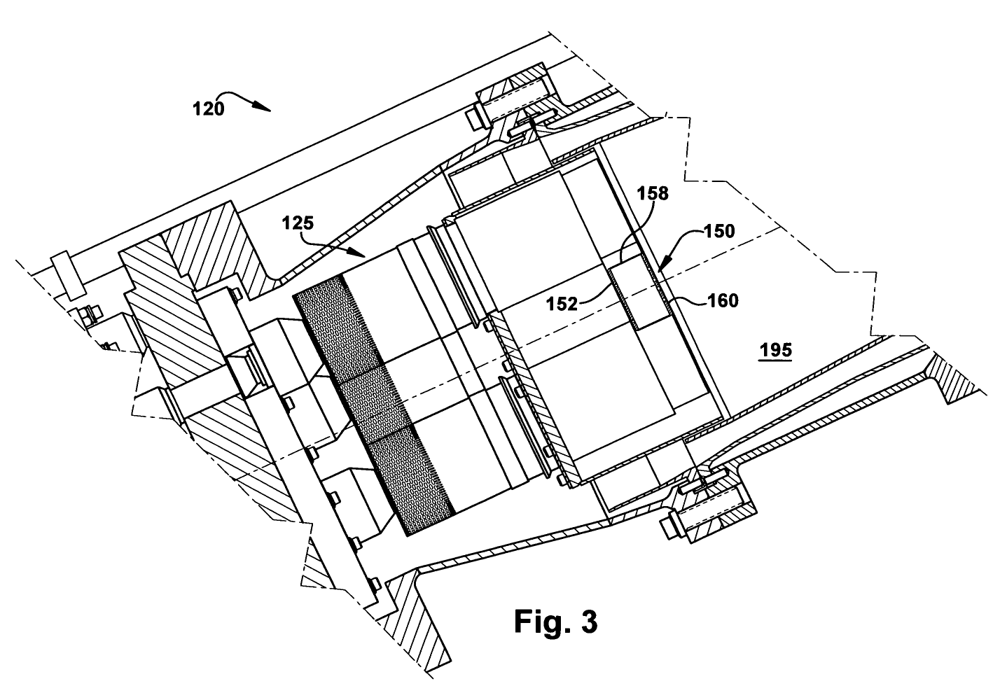

In use, the resonator 150 may be tuned to remove a specific combustion dynamic frequency. For example, but limiting of, combustion dynamic frequencies may range from about 1000 hz to about 4000 hz, furthermore combustion dynamic frequencies may occur from any frequencies greater than about 1000 hz. FIGS. 3 and 4 illustrate the resonator 150 installed within a combustion can 120. Referring specifically to FIG. 3, which is a schematic side view, illustrating the installed location of a resonator in accordance with an embodiment of the present invention. The combustion can 120 includes a plurality of fuel nozzles 125. The second side 160 of the resonator 150 may be axially located near the downstream ends of the fuel nozzles 125. In an embodiment of the present invention, the cavity 158, first side 152, and second side 160 are joined to form the resonator 150. The flow path 195 illustrates the downstream flow of the working fluid and the first side 152 illustrates an upstream location within the combustion can 120.

Referring now to FIG. 4, which is a schematic view facing upstream, of the resonator of FIG. 3, in accordance with an embodiment of the present invention. Some combustion systems incorporate an effusion plate 400 having a center cap area 180 (illustrated in FIG. 5). Typically, the center cap area 180 is located in a region that may experience peak screech dynamics. The resonator 150 may be installed in the location that normally or generally occupies the center cap area 180. Hence, the second side 160 may significantly dampen the dynamics. Furthermore, by installing the resonator 150 near the center cap area, installation costs of a dynamics-dampening device may be significantly reduced.

Referring now to FIG. 5, which is a schematic view, facing upstream, illustrating the installed locations of a plurality of resonators in accordance with an alternate embodiment of the present invention. Due to the varying nature of combustor dynamics frequencies, it may be desirable to provide multiple resonators 150. An alternate embodiment of the present invention may include at least one resonator 150 installed circumferentially about the combustion can 120. Here, the present invention allows for the flexibility of configuring and locating the resonator 150 to the frequency and location where the most effective dynamic dampening may occur. Furthermore, an alternate embodiment of the present invention may include a plurality of resonators 150 installed circumferentially about the combustion can 120 and a resonator 150 installed in the center of the plurality of the fuel nozzles 400.

Although the present invention has been shown and described in considerable detail with respect to only a few exemplary embodiments thereof, it should be understood by those skilled in the art that we do not intend to limit the invention to the embodiments since various modifications, omissions and additions may be made to the disclosed embodiments without materially departing from the novel teachings and advantages of the invention, particularly in light of the foregoing teachings. Accordingly, we intend to cover all such modifications, omission, additions and equivalents as may be included within the spirit and scope of the invention as defined by the following claims.

What is claimed is:

1. A system for dampening combustor dynamics, the system comprising:
a combustion system comprising a plurality of combustion cans, wherein each combustion can comprises a plurality of fuel nozzles mounted adjacent an effusion plate; and
at least one resonator installed adjacent a head-end region of combustion can, the at least one resonator comprising:
a first side comprising a plurality of holes forming a cold side hole pattern;
a second side comprising a plurality of holes forming a hot side hole pattern; and
a cavity substantially defined by the first side and the hot side;
wherein the cold side hole pattern is oriented such that each of the plurality of holes in the cold side hole pattern allows for a jet of a cooling air to substantially impinge a second side facing surface; and wherein the hot side hole pattern is oriented such that each of the plurality of holes in the hot side hole pattern allows for a jet of a working fluid to substantially impinges a first side facing surface.

2. The system of claim 1, wherein the at least one resonator has a substantially cylindrical shape.

3. The system of claim 1, wherein the at least one resonator is installed around a center cap area adjacent the effusion plate.

4. The system of claim 1, wherein the number of the plurality of holes forming the cold side hole pattern is less than the number of holes forming the hot side hole pattern.

5. The system of claim 4, wherein the size of the each hole among the cold side hole pattern is smaller than the size of each hole among the hot side hole pattern.

6. The system of claim 1, wherein the cold side hole pattern is configured to direct the cooling air through the cavity.

7. The system of claim 1, wherein the resonator is configured to dampen combustion dynamic frequencies from about 1000 Hz to about 4000 Hz.

8. The system of claim 1, wherein the at least one resonator is configured to dampen combustion dynamic frequencies from about 1000 Hz or greater.

9. The system of claim 1, wherein the at least one resonator is circumferentially mounted adjacent the effusion plate.

10. The system of claim 3, further comprising at least one additional resonator is circumferentially mounted adjacent the effusion plate.

11. A system for dampening combustor dynamics, the system comprising:
a combustion system comprising a plurality of combustion cans, wherein each combustion can comprises a plurality of fuel nozzles mounted adjacent an effusion plate; and
at least one resonator installed adjacent a head-end region of combustion can, the at least one resonator comprising:
a first side comprising a plurality of holes forming a cold side hole pattern;
a second side comprising a plurality of holes forming a hot side hole pattern; and
a cavity substantially defined by the first side and the second side;
wherein the cold side hole pattern is oriented such that each of the plurality of holes in the cold side hole pattern allows for a jet of a cooling air to substantially impinge a second side facing surface; and wherein the hot side hole pattern is oriented such that each of the plurality of holes in the hot side hole pattern allows for a jet of a working fluid to substantially impinges a second side facing surface; and
wherein the at least one resonator is installed around a center cap area adjacent the effusion plate.

12. The system of claim 11, wherein the first side has a substantially circular shape and wherein the second side has a substantially circular shape.

13. The system of claim 11, wherein the number of holes forming the cold side hole pattern is less than the number of holes forming the hot side hole pattern.

14. The system of claim 11, wherein the diameter of the each hole among the cold side hole pattern is smaller than the diameter of each hole among the hot side hole pattern.

15. The system of claim 11, wherein the first side is configured to direct the cooling air through the cavity.

16. The system of claim 11, wherein the at least one resonator dampens combustion dynamic frequencies from about 1000 Hz to about 4000 Hz.

17. The system of claim 16, wherein the at least one resonator is configured to damped combustion dynamic frequencies from about 1000 Hz or greater.

18. The system of claim 11, further comprising at least one additional resonator circumferentially mounted within the combustion can adjacent the effusion plate.

19. A system for dampening combustor dynamics, the system comprising:
a casing;
a liner disposed with the casing;
a combustion system disposed within the casing, the combustion system comprising a plurality of combustion cans wherein each combustion can comprises a plurality of fuel nozzles mounted adjacent an effusion plate; and
at least one resonator installed adjacent a head-end region of combustion can, the at least one resonator comprising:
a first side comprising a plurality of holes forming a cold side hole pattern;
a second side comprising a plurality of holes forming a hot side hole pattern; and
a cavity substantially defined by the first side and the second side;
wherein the cold side hole pattern is oriented such that each of the plurality of holes in the cold side hole pattern allows for a jet of a cooling air to substantially impinge a second side facing surface; and wherein the hot side hole pattern is oriented such that each of the plurality of holes in the hot side hole pattern allows for a jet of a working fluid to substantially impinges a second side facing surface;
wherein the at least one resonator is installed around a center cap area adjacent the effusion plate;
wherein the resonator dampens pressure oscillations from about 1000 Hz to about 4000 Hz;
wherein the number of holes forming the cold side hole pattern is less than the amount of holes forming the hot side hole pattern; and
wherein the diameter of the each hole among the cold side hole pattern is smaller than the diameter of each hole among the hot side hole pattern.

20. The system of claim 19, wherein the at least one resonator dampens pressure oscillations from about 1700 Hz to about 2900 Hz.
